(19) United States
(12) Patent Application Publication
(10) Pub. No.: US 2012/0001436 A1
(43) Pub. Date: Jan. 5, 2012

(54) POWER GENERATOR USING A WIND TURBINE, A HYDRODYNAMIC RETARDER AND AN ORGANIC RANKINE CYCLE DRIVE

(75) Inventors: Samuel M. Sami, Carlsbad, CA (US); Edwin E. Wilson, Colleyville, TX (US); Dean J. Bratel, New Berlin, WI (US); John H. Batten, Racine, WI (US)

(73) Assignee: TWIN DISC, INC., Racine, WI (US)

(21) Appl. No.: 12/973,583

(22) Filed: Dec. 20, 2010

Related U.S. Application Data
(60) Provisional application No. 61/360,704, filed on Jul. 1, 2010.

(51) Int. Cl. F01K 25/08; F03D 9/00; F01K 23/16

(52) U.S. Cl. 290/55; 60/671; 60/651

(57) ABSTRACT

An electric power generating system is provided that uses a wind turbine to generate waste-heat that is utilized in an organic Rankine Cycle drive that converts heat energy into rotation of a generator rotor for generating electricity. A hydrodynamic retarder may be provided that dissipates heat into a hot fluid by directing the flow of the fluid through the hydrodynamic retarder in a manner that resists rotation of blades of the wind turbine. The hot fluid circulating in the hydrodynamic retarder is a thermal heat source for vapor regeneration of organic heat exchange fluid mixture(s) used in the Rankine cycle, expansion of the organic heat exchange fluid being converted into rotation of the generator rotor.

### CROSS REFERENCE TO RELATED APPLICATION

This Non-Provisional Application claims the benefit of and priority to U.S. Provisional Patent Application Ser. No. 61/360,704, filed Jul. 1, 2010, which is expressly incorporated by reference herein in its entirety, as if fully set forth herein.

### BACKGROUND OF THE INVENTION

1. Field of the Invention

The present invention relates to electric power generating systems, and more specifically, to wind-powered electric power generating systems, as well as corresponding methods of producing electric power from wind.

2. Description of the Related Art

As understood, there is an urgent need for renewable energy. The renewable energy industry has experienced dramatic changes over the past few years. Deregulation of the electricity market failed to solve the industry's problems. Also, unanticipated increases in localized electricity demands and slower than expected growth in generating capacity have resulted in an urgent need for alternative energy sources, particularly those that are environmentally sound. Recent problems in electricity production emphasize the urgent need for a renewable approach to support our power system, increase its existing capacity and, equally important, benefit the environment by both reducing the need to build more power plants, and utilizing environmentally friendly chemicals.

Increasing generation of electrical power from the wind appears promising for addressing at least some of these concerns. Generating electrical power from the wind has been widely used from the beginning of the 20^{th} century. Various devices such as airplane-type propellers, fabric sails, and hoops (Darius Hoops) have been employed to capture the kinetic energy contained in the wind. This energy is then used to either turn an electrical generator or alternator directly in the case of smaller units, or through a speed-increasing step-up gearbox with high gear ratios in larger units.

Since windmills were first introduced, their designs have grown substantially more complex. Substantial efforts have been made to produce windmills that are able to produce more power and be more controllable than their predecessors. Windmills that are being currently used, modern wind turbines, are very complex both in their structure and in their control. In some cases, the rotational speed at which the wind turbine blades turn, and therefore the speed of the generator or alternator, is controlled by varying the pitch of the blades. Varying the pitch of the blades requires complex mechanical joints and controls that have limited use lives.

Furthermore, elaborate control systems are required in modern wind turbines to maintain required output frequencies (50 Hz or 60 Hz in varying wind speeds and electrical loads). When electrical power factor correction is required, this can be accomplished by using, for example, banks of stationary capacitors or rotating capacitors. Capacitors tend to generate heat while online which can break down their internal material(s) over time. In addition to capacitors for electrical power factor correction, many wind turbines include over-speed devices that prevent the propellers from over-speeding in high winds. Such over-speed devices include mechanical brakes that reduce rotating speeds of rotating components of the wind turbine and which can generate substantial amounts of heat in the process.

Moreover, the main components of wind turbines are provided within nacelles that sit on top of the support towers of the wind turbines. Support towers of wind turbines can be hundreds of feet tall. Accordingly, technicians must climb all the way up the support towers and into the nacelles, which takes time and can be exhausting, to inspect or perform maintenance or repairs to any of these major components.

Some attempts have been made to increase system efficiency of wind turbines and even store wind energy by using the rotating blades of wind turbines to compress air which can be later released for performing work. Another attempt used the electricity produced by a wind turbine to energize an electric heater that boils water to produce steam that drives a steam-powered generator according to known concepts of the Rankine Cycle.

A Rankine Cycle (RC) engine is a standard steam engine that utilizes heated vapor to drive a turbine. FIG. 1 illustrates the basic components of a Rankine Cycle circuit. As shown in FIG. 1, in moving from position 1 to position 2, a working fluid is pumped from low to high pressure. Because the fluid is a liquid at this stage, the pump requires little input energy. Next in the process, in moving from position 2 to position 3, the high pressure liquid enters a boiler where it is heated at a constant pressure by an external heat source to become a dry saturated vapor. Then, the dry saturated vapor expands through a turbine, generating power, as the process moves from position 3 to position 4. This decreases the temperature and pressure of the (steam) vapor, and some condensation may occur. Moving from position 4 to position 1, the wet (steam) vapor then enters a condenser where it is condensed at a constant pressure to become a saturated liquid. Such conventional Rankine Cycle can require substantial amounts of heat input to vaporize the water into steam.

All such potential issues associated with existing wind turbines can lead to periodic system inefficiencies and, over time, can require substantial amounts of labor and costs to maintain the wind turbines in proper working order.

### SUMMARY OF THE INVENTION

The present inventors have recognized that a conventional Rankine Cycle may not be practical to implement with a wind turbine because of the large amount of heat that is required to drive the process. The inventors have further recognized that known wind turbines may not produce sufficient waste-heat to drive even modified versions of the Rankine Cycle, such an organic Rankine Cycle, even though such an organic Rankine Cycle may be operable with relatively less heat input than the conventional Rankine Cycle.

According to a first aspect of the preferred embodiment, an electric power generating system is provided that includes a wind turbine and a retarder which may be a hydrodynamic retarder that is configured to generate large amounts of waste-heat while providing a resistive force to rotation of turbine blades. This may allow the wind-powered rotation of the turbine blades to be converted into enough heat that can vaporize an organic heat exchange fluid. Corresponding expansion of the organic heat exchange fluid may then be used to drive rotation of a generator rotor for generating electricity.

According to a broad aspect of the preferred embodiments, there is an electric power generating system using an organic mixture which comprises a waste-heat boiler which is adapted to a Rankine cycle to power turbines for driving an electric generator. The waste-heat boiler uses waste heat generated by the hydrodynamic retarder that is used to transfer rotating power from a prime mover, such as a wind turbine, to a rotating driven load such as an electrical generator. The hot circulating fluid in the hydrodynamic retarder is a source for vapor regeneration of an organic heat exchange fluid mixture at temperatures from 75° C.-160° C.

In another aspect of the invention, the organic heat exchange fluid includes quaternary refrigerant organic mixtures operative at temperatures between about 23° C. to about 160° C. within the Rankine cycle drive. Such relatively low operating temperatures may allow polymeric piping or other plumbing of the Rankine cycle drive to extend further from the heat source, which may allow the generator to be located outside of a nacelle of the wind turbine, for example, on the ground or other location that facilitates easy inspection and maintenance of the generator. The polymeric piping may be an insulated, duplex, polymeric pipe that carries the quaternary refrigerant organic mixtures from hydrodynamic retarder to and from the waste boiler. Such polymeric pipe may reduce heat loss within portions of the system in which the polymeric pipe is used. Doing so may enhance the heat to power efficiency of the Rankine cycle. Connecting the Rankine cycle components and hydrodynamic retarder with polymeric pipe may also facilitate maintenance and inspection of the Rankine cycle components, electrical power generator, and gear box by allowing them to be fluidly connected while being mounted outside of a wind turbine nacelle; for example, while housed within a stand-alone service building near a tower base of a wind turbine, in a readily accessible portion of the tower, or other suitable location that is outside of the nacelle.

In another aspect of the invention, the system consists of a device to capture the kinetic energy from the wind, which can be airplane propeller-style sails or hoops mounted either vertically or horizontally. This energy rotates a shaft that may or may not drive into a low numerical ratio step-up or step-down gearbox depending on the size and style of the wind conversion device. The output shaft then drives a hydrodynamic device that absorbs this energy based on a cube curve (absorption vs. speed).

In another aspect of the invention, the absorbed energy is converted into heat energy in a heat transfer fluid that is circulated through the hydrodynamic device. The conversion of energy is very high with the only losses being that of radiation of heat through the outer walls of the hydrodynamic device. This can be minimized by wrapping the outside of the device in a thermal insulating blanket. The wind energy, now contained in the form of heat energy, in the heat transfer fluid is routed though a heat exchanger which transfers the energy to a refrigerant. This heat exchanger can be mounted within the nacelle of the windmill or mounted on a stationary platform on the ground.

In yet another aspect of this embodiment, when the heat exchanger is installed on the ground, the heat transfer fluid is pumped through a vertical, insulated, duplex poly pipe via a dual passage rotary union which allows the windmill to rotate 360 degrees in order to catch the wind. The refrigerant can be homogeneous or a mixture made up of several refrigerants with different boiling and condensing points to accommodate a variety of ambient operating temperatures.

According to yet another aspect, after the heat transfer fluid is heated in the primary heat exchanger, it flows to a conversion device known as a vapor turbine. To flow through the vapor turbine, the fluid flows through a series of nozzles which direct their outputs, of what is emitted as high pressure refrigerant vapors, to a series of rotating blades. The heat energy is then converted back into kinetic energy and turns the output shaft of the turbine. An input shaft of an electrical generator or alternator may be connected to the turbine's output shaft.

In a still further aspect, partially cooled heat transfer fluid now flows out of the vapor turbine in the form of a mixture of refrigerant vapors, through a secondary heat exchanger, also called a regenerator, which removes additional heat and uses it to pre-heat the heat transfer fluid that flows into the primary heat exchanger. The heat transfer fluid, now mostly a warm liquid, flows through an electrically-driven centrifugal pump where its flow and pressure increase and is sent through a fluid-to-air or water-cooled condenser where the remaining heat is removed to the atmosphere or to cooling water.

Another feature of the present invention is to provide a method of generating electric power using an organic mixture and which comprises feeding a waste-heat boiler adapted to a Rankine cycle, with hot fluid from a hydrodynamic retarder providing the thermal heat source for vapor generation of an organic heat exchange fluid mixture at a temperature higher than 160° C. circulated in a closed circuit for driving turbines of the Rankine cycle, the turbines being connected to a drive shaft of the wind turbine and electric generator.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred embodiments of the invention are set forth in the following description and are shown in the drawings and are particularly and distinctly pointed out and set forth in the appended claims.

FIG. 1 is a prior art schematic diagram illustrating a conventional Rankine cycle circuit;

FIG. 2 is a schematic illustration of an electric power generating system constructed in accordance with a preferred embodiment;

FIG. 3 is a graph illustrating the entropy temperature thermodynamic properties of a refrigerant organic mixture used in a preferred embodiment;

FIG. 4A is a schematic top plan view of another embodiment of an electric power generating system;

FIG. 4B is a schematic top plan view of a variant of a portion of the electric power generating system of FIG. 4A;

FIG. 5 is a schematic illustration of a hydrodynamic retarder usable with an electric power generating system of the invention;

FIG. 6 is a schematic diagram of another embodiment of an electric power generating system;

FIG. 7 is a schematic diagram of a variant of the electric power generating system of FIG. 6;

FIG. 8 is a graph illustrating a comparison regarding efficiency of various fluids at various temperatures;

FIG. 9 is a graph illustrating a comparison between a typical wind turbine and a wind turbine incorporated into an electric power generating system of the present invention;

FIG. 10 is a graph illustrating a typical performance of an electric power generating system of the invention with the hot fluid carrying the waste heat at an operating temperature of about 220° F.;

FIG. 11 is a graph illustrating gross outputs of an electric power generating system of the invention at different ambient temperatures;

FIG. 12 is a graph illustrating characteristics of an electric power generating system of the invention under differing operating conditions; and

FIG. 13 is a graph illustrating characteristics of an electric power generating system of the invention that incorporates the quaternary refrigerant mixture, under differing operating conditions.

### DETAILED DESCRIPTION OF THE PREFERRED EMBODIMENTS

Referring now to the drawings and more particularly to FIG. 2, a schematic illustration of an electric power generation system 5 of the preferred embodiments is shown. A wind turbine 6 is provided and supplies harnessed energy to a hydrodynamic drive 7. Drive 7 works together with an ORC 8 to provide an output supplied to, for instance, an electric generator 9. Details of the power generation system of the preferred embodiments are provided hereinafter.

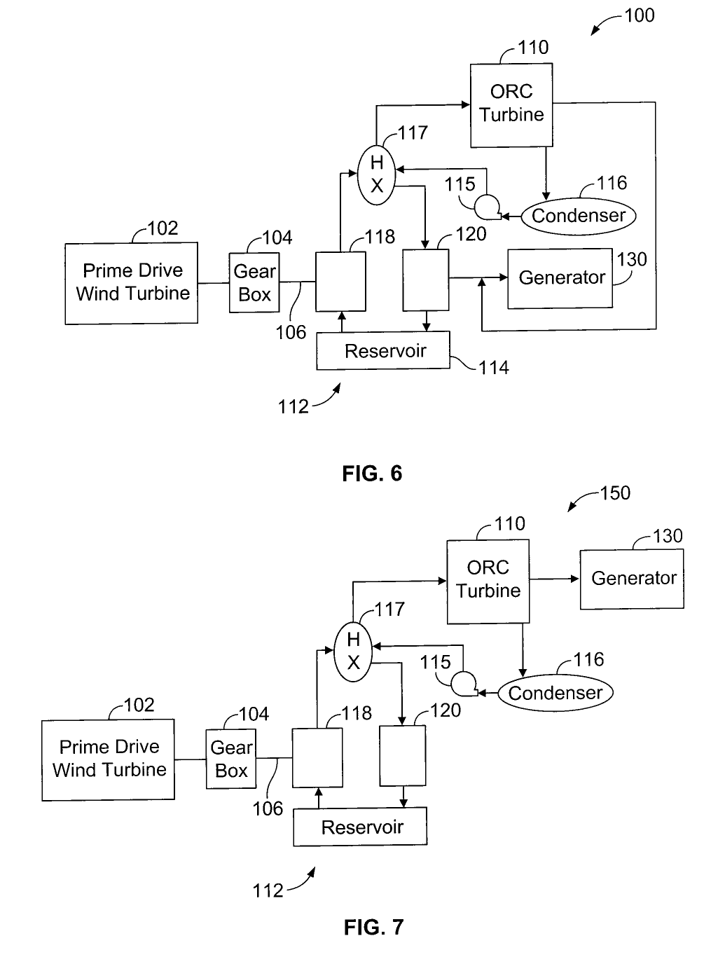

Turning now to FIG. 4A, there is shown generally at 10 an electric power generating system which has been adapted for the present invention (shown more completely in FIGS. 6 and 7, discussed below). It includes a waste-heat boiler 11 which is adapted to equipment normally found in a Rankine cycle system to power turbines. A high pressure turbine 12 and a low pressure turbine 13 cooperate with the waste-heat boiler 11 and are connected to a common drive shaft 14 of electric generator 15 to generate electric power.

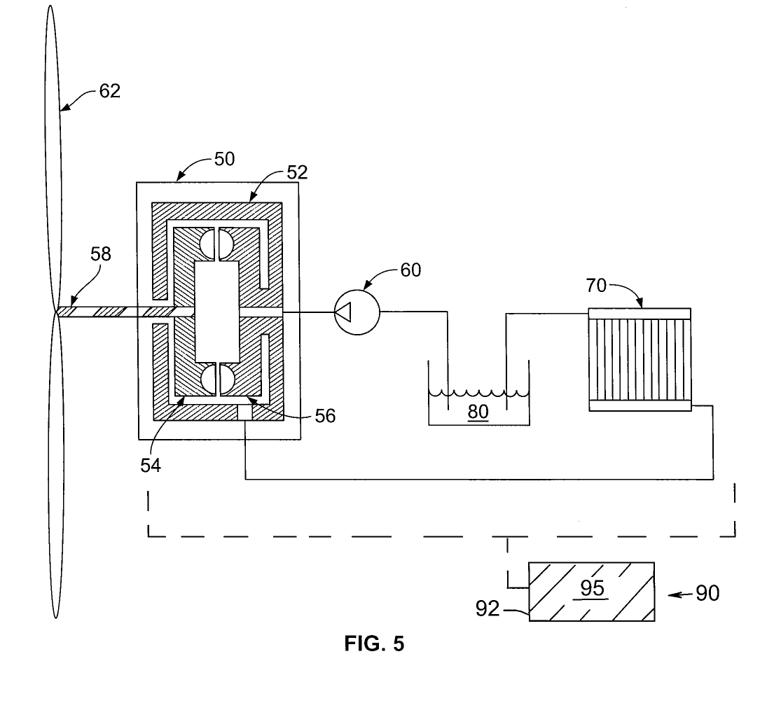

Still referring to FIG. 4A, the waste-heat boiler 11 uses waste heat dissipated from a hydrodynamic retarder (discussed below in connection with, for example, FIG. 5 and labeled as “/50” therein) circulating fluid as a source of heat for vapor regeneration of an organic heat exchange fluid mixture. As used herein, the definitions (phases), e.g., “organic heat exchange fluids”, “organic heat exchange fluid mixtures”, “heat exchange organic mixtures”, “organic refrigerant mixtures”, “organic refrigerant mixture(s)”, and “variants therefore”, are used synonymously. As herein shown, the outlet 17 of the external boiler is connected via suitable ducting 18 to an inlet 19 of the waste-heat boiler 11. The heat dissipated from the fluid is convected through the waste-heat boiler 11 and passed through a duct segment 21 where a reheat exchanger 23 and a super-heat exchanger 22 are provided, whose purpose will be described later.

Still referring to FIG. 4A, the hot fluid then passes through an evaporator 20 to heat the liquid organic fluid mixture, and the cooled fluid is then evacuated through the outlet duct 24. The organic fluid mixture to be heated is fed to the waste-heat boiler 11 through an inlet conduit 25 by a pump 26 which is connected to the outlet 27 of a regenerative heater 28. The organic heat exchange fluid mixture at the inlet conduit 25 is in a liquid saturated state after leaving a condenser 30, and at a temperature depending upon the heat source, e.g., a minimum of about 7° C. Condenser 30 is preferably configured based at least in part on the particular end-use environment, such as the installation location of the system or system components. For example, in one embodiment, the wind turbine 6 is installed on-shore and the condenser 30 is air cooled. In another embodiment, wind turbine 6 is installed off-shore and the condenser 30 is liquid cooled, preferably using water from the body of water in which the wind turbine 6 is installed as a coolant for the condenser 30.

Still referring to FIG. 4A, regardless of the particular configuration of condenser 30, it is adapted to remove sufficient heat from the vaporous organic heat exchange fluid mixture to change it into a liquid saturated fluid. This liquid saturated fluid passes through a) the regenerative heaters 28 and 35 where it is heated and then b) through the evaporator 20 where it absorbs heat from the fluid passing through the boiler 11. At the outlet 29 of the evaporator 20, the heat exchange fluid mixture is in the form of a saturated vapor and it is then fed to a super-heat exchanger 22, in contact with the hot fluid, where the temperature of the fluid rises to a maximum of approximately 245° C. and changes to super-heated vapor. This super-heated organic fluid vapor mixture is then fed to turbine 12 where it drives the turbine blades 12b connected to the drive shaft 14.

Referring now to FIG. 4B, in this embodiment, the organic heat exchange fluid mixture leaving the low pressure turbine 13 is in a superheated vapor state and fed to and serves as a heat source for a regenerative heater 35. The superheated vapor is fed from heater 35 to condenser 30, which condenses the saturated vapor or wet vapor into its liquid phase. Pump 36 (FIG. 4B—P₃) pumps this condensed liquid back through regenerative heater 35 where it is heated to a temperature of about 60° C. The outlet 31 of the condenser 30 is fed via heater 35 to a pump 32 (FIG. 4B—P₂) which pumps this liquid heat exchange fluid mixture to regenerative heater 28, as seen in FIG. 4A.

Referring again to FIG. 4A, in the regenerative heater 28, the liquid heat exchange fluid mixture is rejoined and mixed with the hotter liquid heat exchange mixture fed thereto by the outlet conduit 33 of the high-pressure turbine 12. This rejoined mixture of heat exchange fluids, at different temperatures, causes the temperature of the fluid mixture from the condenser to rise so that the rejoined liquid mixture exits the regenerative heater 28 via outlet 27, where it is pumped by pump 26 to the inlet conduit 25 of the waste-heat boiler 11, and the entire cycle repeats itself.

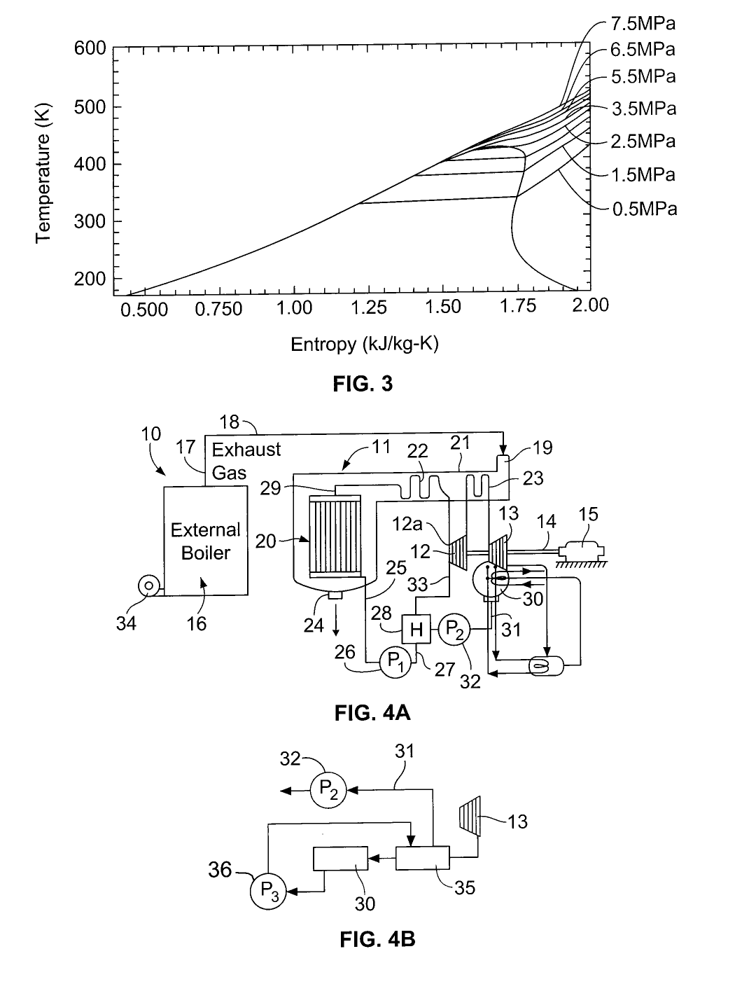

FIG. 3 illustrates the variation of the pressure lines in the sub-cooled, latent and superheated regions, with the change of temperature and entropy. This diagram also shows the critical temperature and pressure of the refrigerant mixture in question. These parameters determine the limitations of the use and application of the refrigerant mixture. As understood in the art, the entropy represents the irreversible losses in the process.

Turning now to FIG. 5, a hydrodynamic retarder 50 consists of three primary components plus the hydraulic fluid 80. A housing 52, which must have a fluid tight seal relative to the drive shafts, contains the fluid as well as turbines 54, 56. A heat exchanger 70 is also provided. The two turbines 54, 56 include one connected to an input shaft 58, known as the rotor (54). The other is connected to the housing 52, and is known as the impeller (56). Rotor 54 is rotated by the wind turbine 62. The hydraulic fluid 80 is directed to the hydrodynamic retarder 50 via a pump 60 whose displacement provides the necessary pressure for operation and flow to heat exchanger 70.

Namely, and still referring to FIG. 5, in this embodiment, the rotor 54 of hydrodynamic retarder 50, which is driven by the wind turbine 62, accelerates the fluid which is then decelerated by the impeller 56. The turbulent fluid absorbs the torque from the wind turbine 62. The fluid is pressurized into the working chamber between the rotor and impeller. The rotor rotates and accelerates the fluid and is transferred to the outside diameter of the impeller as the fluid passes over it. The fluid is then decelerated to the inside diameter of the impeller and transferred to the inside diameter of the rotor. The energy required to accelerate the fluid is taken from the kinetic energy of the wind turbine and provides the retarding effect. This retarding effect is converted to heat within the fluid.

FIG. 6 illustrates a preferred embodiment of an integrated system 100 including an ORC turbine 110 and a hydrodynamic retarder 112, shown schematically and being largely analogous to hydrodynamic retarder 50 of FIG. 5. As described with regard to FIG. 5, in the embodiment of FIG. 6, retarder 112 includes an input turbine 118 and an output turbine 120 coupled to generator 130. It is further appreciated that more than the ORC turbine 110 may be connected to the drive shaft of the electrical generator driven by hydrodynamic retarder 112.

Still referring to FIG. 6, the prime load is generated by a prime drive shaft of wind turbine 102 which is connected to a gear box 104 whose output drives a hydrodynamic retarder connecting shaft 106. A Rankine cycle turbine 110 is fully driven by the waste-heat boiler 11 (FIG. 4A) using hot fluid circulating in a hydrodynamic retarder 112. It is further pointed out that the heat exchange organic mixture 114 (contained in reservoir 114 and pumped by pump 115) is a multi-component mixture which enables the system to generate electricity at low temperatures and pressures. Such capability allows this embodiment to be constructed and operated in a highly economic manner, as the system is not concerned with problems inherent with high-pressure containers where condenser 116 (corresponding to 30 in FIG. 4) is a water-cooled condenser and can also be an air-cooled condenser, depending on the application.

FIG. 7 illustrates an optional integrated system 150 of the ORC turbine 110 and hydrodynamic retarder 112. The prime load generated by the wind turbine blades is transferred to the shaft of prime drive 102 and is connected to the gear box 104 which has an output that drives the connection shaft of the hydrodynamic retarder 112. The Rankine cycle turbine 110 is fully driven by the waste-heat boiler 11 (FIG. 4A) using hot fluid circulating in the hydrodynamic retarder where the ORC turbine is connected to the electrical generator drive shaft. As with the condensers 30 and 116 of FIG. 4A and FIG. 6, respectively, the condenser 116 of this embodiment may be a water cooled condenser and may alternatively be an air-cooled condenser depending on the application, for example, the end-use environment and/or installation location.

Referring once again to FIG. 4A to describe, e.g., the heat exchange organic mixture, it is preferably a multi-component mixture which enables the system to generate electricity at low temperatures and pressures. Such configuration provides a significant benefit in that it permits the construction of the system in a much more economic manner in which the system does not need to be concerned with problems inherent with high-pressure containers. This may be particularly beneficial for embodiments in which the wind turbines 6 are installed in remote areas, in either on-shore or off-shore installations.

Still referring to FIG. 4A, the inlet and outlet vapor conditions at the waste-heat boiler 11 ensure that the Rankine cycle operates at low pressures and temperatures and will also consume a minimum of heat from the waste-heat boiler 11. Accordingly, the boiler efficiency is not compromised. The regenerative heaters 28 and 35 enhance the thermal efficiency of the organic Rankine cycle. The organic refrigerant mixtures used in the Rankine cycle are hydroflurocarbons (HFCs) based and preferably no chloroflurocarbons (CFCs) and or hydrochlorofluorocarbons (HCFCs) are used. The selection of the mixture components depends on the heat source temperature, boiling temperature and pressure of the mixture, and the ability to produce higher thermal energy between about 23° C. and about 160° C.

Stated another way, the particular composition of refrigerant mixture(s) in this invention can be adjusted to boil the mixture and generate power at a wide range of heat source temperatures from as low as about 23° C. The refrigerant mixtures are characterized by variable saturation temperatures, and their boiling points can be tailored to maximize the heat absorption at the evaporator and produce an optimized power. The quaternary refrigerant mixtures of the present invention can produce power from captured low and medium heat sources in applications such as the hydrodynamic retarder/cooler. Further, the present quaternary refrigerant mixtures have a long life-cycle and require reduced maintenance and repair costs. These factors result in a relatively short payback period for the initial investment compared to existing ORC systems.

The organic heat exchange fluid mixture can also be binary, ternary, or quaternary mixtures. From experience, it has been found that a quaternary refrigerant mixture produces the best benefits for an environmentally sound low-pressure system. Based on the environmental information available on the components of the present organic mixtures, they are believed to be environmentally sound. Furthermore, the pressure ratio of the proposed mixtures under the operating conditions as discussed above is comparable and acceptable such that a system such as system 100 is not considered a high pressure vessel. Therefore, the proposed system is acceptable for all typical applications.

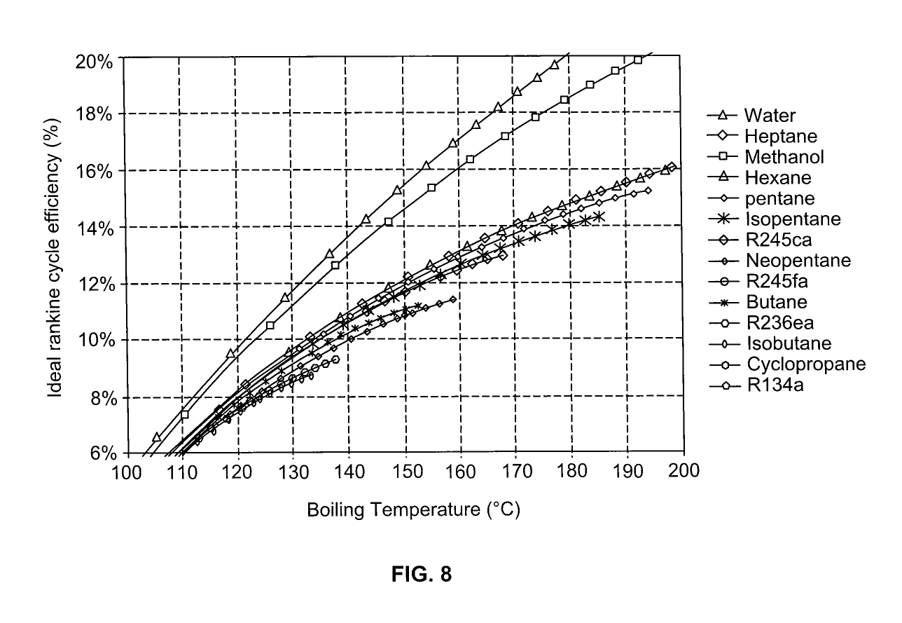

FIG. 8 is a graph that illustrates the efficiency of an array of materials at different boiling temperatures. In contrast to some of the illustrated single fluid materials, the preferred refrigerants or quaternary heat exchange fluids used in the present invention provide heat recovery efficiencies that are significantly greater. For a more detailed discussion of the preferred mixtures, reference is made to US Publication No. 2010/0126172, the disclosure of which is incorporated by reference herein.

In one example, a typical eighty meter diameter wind turbine rotor (5027 m²) operated at various speeds has a conversion efficiency between about 4% to about 35%, depending upon the wind speed, as illustrated in Table 1 below. Wind turbines run less than about 25% of the time due to wind speed and design limitations.

TABLE 1

| Wind speed | Wind speed | Power (KW) | Power (KW) | Conversion |
|---|---|---|---|---|
| (MPH) | (m/s) | Wind | Output | efficiency % |
| 10 | 4.5 | 285 | 110 | 35 |
| 25 | 11.2 | 4453 | 1600 | 34.8 |
| 40 | 17.9 | 18241 | 2000 | 10 |
| 55 | 24.7 | 47419 | 2000 | 4.2 |

A typical wind turbine of 1500 KW functions a maximum 2000 hours per year due to upper and lower limitations on the rotational speed of the blades and the wind velocity resulting in 3,000,000 KWHR yearly. The preferred embodiments can produce 3,200,000 KWHR yearly over 8760 Hours with electricity supplied all year round. In addition to the aforementioned, the proposed invention requires less maintenance and is a reliable renewable energy source compared to conventional wind turbines.

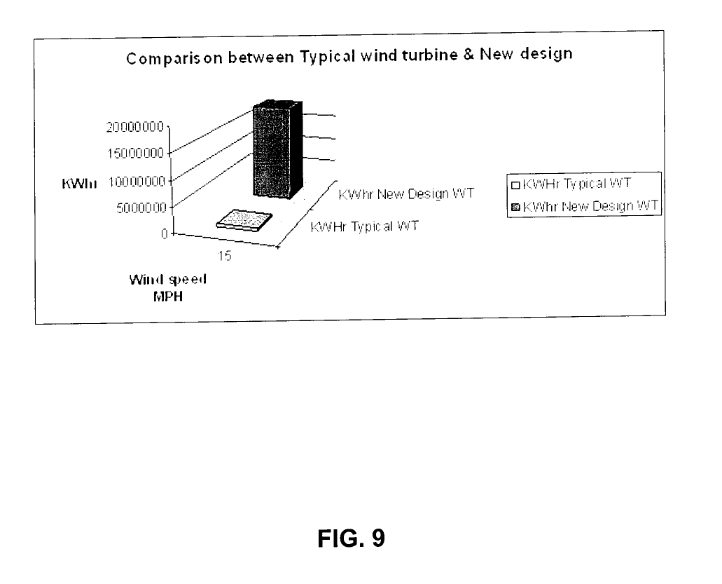

Turning now to FIG. 9 which shows a comparison between a typical wind turbine and that of the current invention, it is noted that at a typical wind speed, the disparity in the annual energy produced in KWHR by a conventional wind turbine compared to that of the new inventive design is significant. It is quite evident that the proposed design may significantly increase the rate energy production of a typical wind turbine, up to several orders of magnitude.

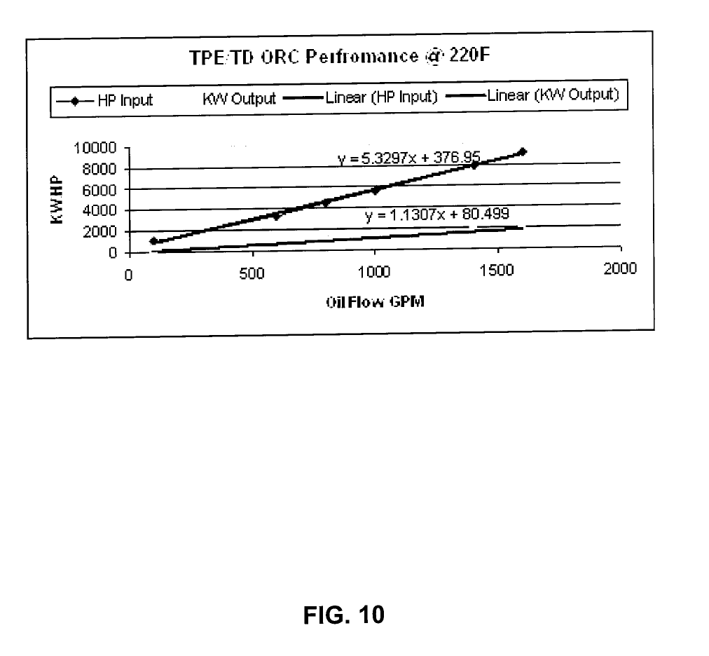

Referring now to FIG. 10, as illustrated in this graph, the retarder controls the hot fluid that drives the ORC and consequently the power produced by the new apparatus. Accordingly, FIG. 10 illustrates such characteristics of the inventive system at various hot fluid flows. At the design temperature of 220 F, larger hot fluid flow provides higher torque at the torque retarder and subsequently higher heat input to the ORC. Similar characteristics can be obtained at different hot fluid temperatures in some embodiments.

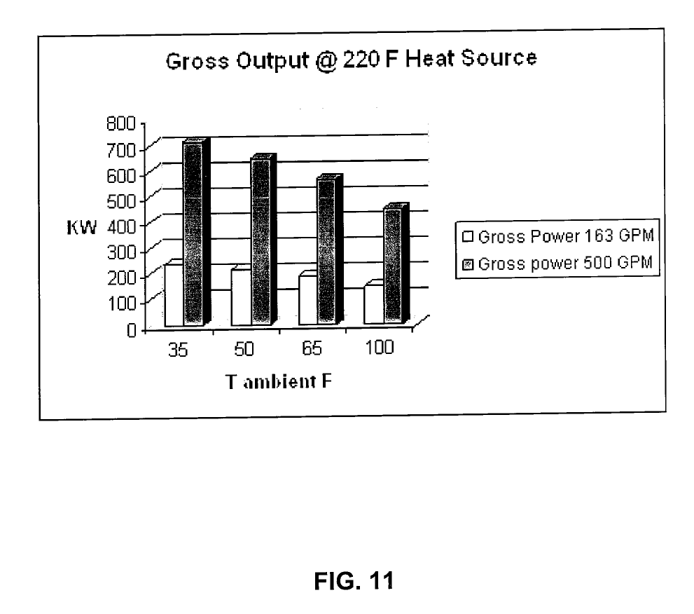

Turning now to FIG. 11, the ORC/wind turbine power output is significantly influenced by the site installation and its ambient conditions. FIG. 11 shows the impact of varying the ambient conditions at the gross output of the proposed design at different heat flows. It can also be seen that the use of the proposed design in off-shore applications will significantly produce more power since the sink temperature of the ORC is lower where the condenser is cooled by cold sea water deep under the sea surface.

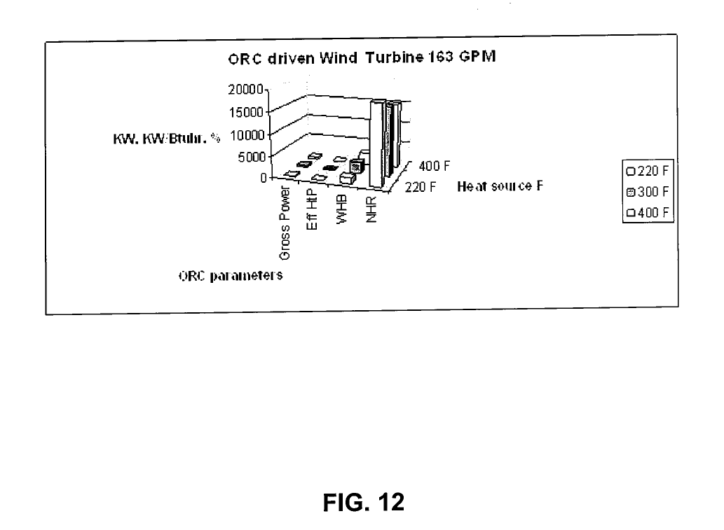

Referring now to FIG. 12, the graph shows typical performance characteristic behaviors of the ORC driven wind turbine at a particular hot fluid flow rate and as functions of various hot fluid sources. Namely, FIG. 12 illustrates characteristics of ORC driven wind turbine at various conditions and temperatures. The graph also shows the impact of the temperature of hot fluid at the gross power produced (KW), thermal conversion efficiency (%), Net Heat Rate (NHR-KW/Btuhr) as well as waste-heat boiler thermal capacity (KW). This graph reveals that the higher the hot fluid temperature, the more gross power is produced and energy in terms of KWHR.

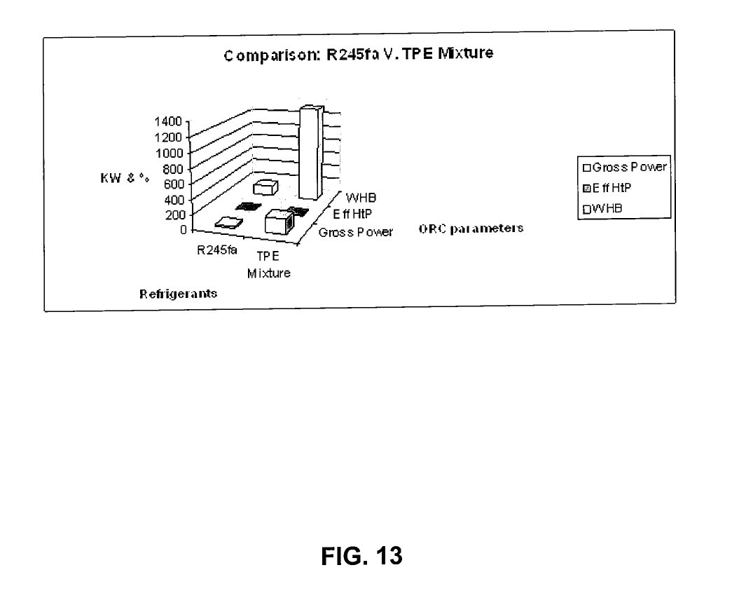

Referring now to FIG. 13, this graph illustrates how selecting a particular refrigerant may influence system performance. FIG. 13 shows the desirability of using various refrigerant mixtures used in this invention versus R 245fa which is a familiar single fluid used in the majority of ORCs on the market. FIG. 13 shows that depending on the particular end-use configuration of the system and end-use location of implementation, a specific refrigerant mixture(s) may provide, at least in part, a particularly desirable high energy output for the system. The use of this refrigerant mixture may even improve economic viability and return on investment projections of the system. As seen in FIG. 13, this refrigerant mixture produces more energy in KWHR that reduces the consumption of fossil fuel and reduces the greenhouse effect and global warming as well as protects our environment.

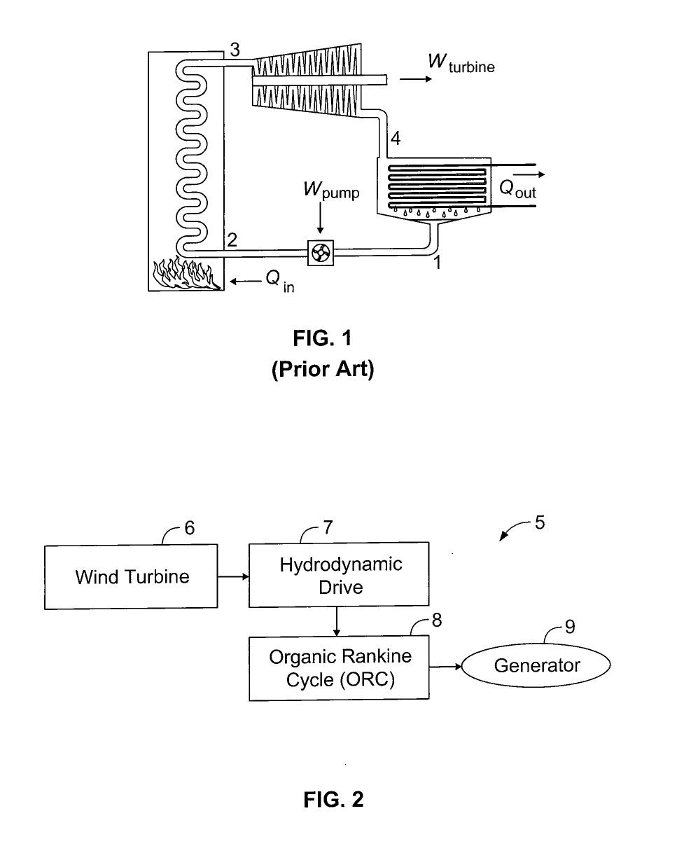

Referring generally now to all of the FIGS. 1-13, it is further noted that, in addition, conversion of wind energy may be maximized by matching the circuit diameter and blading of the hydrodynamic device to that of the fixed pitch blading of the windmill. Due to the inherent absorption characteristics of this device, the windmill is prevented from over-speeding, even in high winds. Wind energy is absorbed at all wind speeds and converted to heat.

Moreover, because the windmill and the generator/alternator are not mechanically coupled to one another, maintaining voltage and frequencies is accomplished without elaborate controls.

Referring now to FIGS. 2-7, for embodiments of power generation system 5 that are incorporated into wind turbine applications, any such embodiments may be configured so that various components of the power generation system 5 are housed outside of a nacelle of the wind turbine. For example, depending on the intended end-use configuration(s), one or more of the hydrodynamic retarder 50, 112, Rankine cycle components, generator 15, 130, and/or corresponding intervening or otherwise cooperating components, are housed in a stand-alone structure, within a lower or otherwise readily accessible portion of the wind turbine tower, or otherwise supported by the ground and spaced from the nacelle.

Still referring to FIGS. 2-7, in such embodiments in which turbine-driven components are housed in the nacelle while other components of the power generation system 5 are connected remotely thereto, the various components are preferably connected to each other with highly insulating piping materials. As one example, polymeric piping carries various fluids throughout and between components of the power generation system 5. Accordingly, the connections that are schematically represented by arrows indicating flow direction in the figures can be made by way of polymeric piping. Preferably, the polymeric piping has a duplex configuration and/or is otherwise configured as a robust and highly insulated conduit. The polymeric piping of such embodiments directs the quaternary refrigerant organic mixtures from hydrodynamic retarder 50, 112 to and from the waste boiler 11, and/or between other components of the power generation system 5. Polymeric piping can be implemented for conveying other fluids throughout the power generation system 5, especially fluids in which heat is desirably maintained.

Furthermore, referring again to FIG. 5, in this embodiment, the power generation system 5 can include a thermal capacitance system 90. The thermal capacitance system 90 in this embodiment includes a container 92 that holds a volume of a phase change material 95 that serves as a thermal capacitor for the system 5. In a preferred embodiment, the phase change material 95 is a black paraffin wax. The black paraffin wax thermally interfaces with at least one of (i) the hydrodynamic retarder, (ii) the organic heat exchange fluid, and (iii) other heat-generating or heat-carrying component of the system 5. In this way, at least some heat from such heat-generating or heat-carrying component is transferred to and stored by the increased temperature of the black paraffin wax.

Still referring to FIG. 5, in this embodiment, the organic heat exchange fluid is directed from the thermal capacitance system 90 at a variable volume and/or rate. The volume and flow rate of the organic heat exchange fluid is controlled by way of conventional electronic controls and valves, which are well known to persons having ordinary skill in the art, so as to produce the desired heat addition to or heat removal from the thermal capacitance system 90. In this regard, when system 5 intakes a relatively small amount of energy but system demands remain high, for example, when the wind is not blowing but generating electricity with the system is desired, then the organic heat exchange fluid is directed through system 5 to thermally interface with the black paraffin wax. In so doing, the organic heat exchange fluid is heated by the stored heat of the thermal capacitance system 90 and can be used for generating electricity as described elsewhere herein in greater detail.

Stated another way, the volume of organic heat exchange fluid, possibly in combination with black wax paraffin, can be varied to accommodate heat storage and subsequent release thereof for use as an energy source that can drive the generator when the wind is not blowing, thereby eliminating the need for storage batteries. In this way, when electrical demand is low, and/or wind speeds exceed rating wind speeds, excessive heat from the hydrodynamic retarder can be stored in the black wax paraffin or phase change material 95. When black paraffin wax is used, it is melted by the hot heat transfer fluid flowing from the hydrodynamic retarder to the waste-heat boiler. In situations where wind is not blowing and/or system 5 experiences an increase in electrical demand, heat can be drawn from the black paraffin wax and transferred into or absorbed by the organic heat exchange fluid. The organic heat exchange fluid then supplies such previously stored heat to the waste-heat boiler. When the organic heat exchange fluid absorbs heat from the black paraffin wax, the wax is correspondingly cooled and this cooling process solidifies the wax and eliminates the need for electrical storage batteries. In this way, the stored heat in the black paraffin wax container 92 acts as a thermal capacitor which can be utilized to correct the electric power factor in power grids where linear loads with a low power factor are found.

If a step-up or step-up gearbox is required, low numerical gear ratios can be utilized because there is no need to maintain a specific speed to the hydrodynamic device. Therefore, greater efficiency is maintained and maintenance costs are reduced.

Although the best mode contemplated by the inventors of carrying out the present invention is disclosed above, practice of the present invention is not limited thereto. It will be manifest that various additions, modifications, and rearrangements of the features of the present invention may be made without deviating from the spirit and scope of the underlying inventive concept.

What is claimed is:

1. An electric power generating system, comprising:
a wind turbine having blades that are rotated by a volume of moving air thereby producing kinetic energy associated with the rotating blades;
a hydrodynamic retarder accepting the kinetic energy from the rotating blades and converting at least some of the kinetic energy from the rotating blades into waste-heat that is dissipated from the hydrodynamic retarder;
a Rankine cycle drive operably coupled to the hydrodynamic retarder and including:
an organic heat exchange fluid that absorbs and is vaporized by the waste-heat dissipated from the hydrodynamic retarder;
a turbine that includes a rotatable turbine component, the turbine directing flow of the vaporized organic heat exchange fluid therethrough such that an expansion of organic heat exchange fluid during vaporization of the organic heat exchange fluid rotates the turbine wheel; and
a generator operatively coupled to the Rankine cycle drive and converting kinetic energy from the rotating turbine wheel into electricity.

2. The system of claim 1, wherein the organic heat exchange fluid includes quaternary refrigerant organic mixtures operative at temperatures between about 23° C. to about 160° C. within the Rankine cycle drive.

3. The system of claim 1, wherein the Rankine cycle drive includes a waste-heat boiler in which heat is transmitted from the waste-heat being dissipated from the hydrodynamic retarder to the organic heat exchange fluid.

4. The system of claim 3, wherein the organic heat exchange fluid is recirculated through the Rankine cycle drive such that vapor regeneration of the organic heat exchange fluid occurs within the waste-heat boiler over time.

5. The system of claim 4, wherein the hydrodynamic retarder includes a hot fluid being heated by and carrying the waste-heat of the hydrodynamic retarder such that dissipating heat from the hot fluid correspondingly dissipates heat from the hydrodynamic retarder.

6. The system of claim 5, wherein the waste-heat boiler defines a heat exchanger that includes (i) an economizer section in which the hot fluid from the hydrodynamic retarder increases the temperature of the organic heat exchange fluid, (ii) an evaporator section in which the organic heat exchange fluid is converted to a saturated vapor, and (iii) a super-heater section in which the saturated vapor is converted into a super-heated gas.

7. The system of claim 6, wherein the waste-heat boiler defines a heat exchanger that includes (i) an economizer section in which the hot fluid from the hydrodynamic retarder increases the temperature of the organic heat exchange fluid, (ii) an evaporator section in which the organic heat exchange fluid is converted to a saturated vapor, and (iii) a super-heater section in which the saturated vapor is converted into a super-heated gas that drives a turbine wheel of a high-pressure turbine that rotates the rotor of the generator.

8. The system of claim 7, wherein the waste-heat boiler further includes a reheat exchanger provided downstream of the super-heater section of the waste-heat boiler, the reheat exchanger reheating the gas vapor flowing out of the high-pressure turbine and using the reheated gas vapor to drive a turbine wheel of a low-pressure turbine that rotates the rotor of the generator.

9. An electric power generating system, comprising:
a wind turbine having blades that are rotated by a volume of moving air so as to define kinetic energy associated with the rotating blades;
a retarder that resists rotation of the wind turbine blades so as to generate waste-heat while the wind turbine blades rotate, the waste-heat dissipating from the retarder;
a Rankine cycle drive operably coupled to the retarder and including an organic heat exchange fluid that absorbs and is vaporized by the waste-heat dissipated from the retarder;
a generator operatively coupled to the Rankine cycle drive so that a rotor of the generator is driven by expansion of the organic heat exchange fluid for generating electricity within the generator; and
wherein the organic heat exchange fluid includes quaternary refrigerant organic mixture operative at temperatures between about 23° C. to about 160° C. within the Rankine cycle drive.

10. The system of claim 9, wherein the retarder is a hydrodynamic retarder that includes a rotor that is rotated by the rotating blades and an impeller that is rotated by the rotor of the hydrodynamic retarder.

11. The system of claim 10, wherein hydraulic fluid transmits torque between the rotor and impeller of the hydrodynamic retarder.

12. The system of claim 11, further comprising a volume of black paraffin wax that thermally interfaces with at least one of (i) the hydrodynamic retarder, and (ii) the organic heat exchange fluid, such that at least some heat from the at least one of the hydrodynamic retarder and the organic heat exchange fluid is absorbed and stored in the black paraffin wax.

13. An method of producing electricity from wind, comprising:
rotating blades of a wind turbine with a volume of moving air; converting kinetic energy associated with the rotating blades into waste-heat; heating a fluid with the waste-heat to an extent that the fluid changes phase from a liquid to a vapor, the fluid expanding in volume while changing phase; and rotating a rotor of a generator directly or indirectly with the expanding fluid so as to generate electricity.

14. The method of claim 13, wherein the expanding fluid rotates a rotatable wheel of a turbine that rotates the rotor of the generator.

15. The method of claim 14, wherein the fluid is an organic heat exchange fluid.

16. The method of claim 14, wherein a retarder converts the kinetic energy associated with the rotating blades into waste-heat that is dissipated from the retarder.

17. The method of claim 16, wherein the retarder is a hydrodynamic retarder.

18. The method of claim 17, wherein the hydrodynamic retarder directs a hydraulic fluid therethrough in a manner that heats the hydraulic fluid.

19. The method of claim 18, wherein heated hydraulic fluid provides the waste-heat that heats the organic heat exchange fluid for changing the phase of the organic heat exchange fluid.

20. The method of claim 19, further comprising a step of absorbing and storing heat from at least one of (i) the hydrodynamic retarder and (ii) the organic heat exchange fluid, with a phase change material.

21. The method of claim 20, wherein the phase change material is black paraffin wax.

22. The method of claim 21, wherein the heat that is stored in the phase change material provides heat that increases the temperature of the organic heat exchange fluid when the wind is not sufficiently blowing and during periods of low electrical demand of the generator.

23. The method of claim 13, wherein the wind turbine is installed on-shore and the fluid changes phase from a vapor to a liquid in an air cooled condenser.

24. The method of claim 13, wherein the wind turbine is installed off-shore and the fluid changes phase from a vapor to a liquid in a liquid cooled condenser.
